(19) United States
(12) Patent Application Publication
(10) Pub. No.: US 2009/0193417 A1
(43) Pub. Date: Jul. 30, 2009

(54) TRACTABLE DATAFLOW ANALYSIS FOR CONCURRENT PROGRAMS VIA BOUNDED LANGUAGES

(75) Inventor: Vineet Kahlon, Princeton, NJ (US)

Correspondence Address: NEC LABORATORIES AMERICA, INC., 4 INDEPENDENCE WAY, Suite 200, PRINCETON, NJ, 08540, US

(73) Assignee: NEC LABORATORIES AMERICA, INC., Princeton, NJ (US)

(21) Appl. No.: 12/354,179

(22) Filed: Jan. 15, 2009

Related U.S. Application Data
(60) Provisional application No. 61/023,114, filed on Jan. 24, 2008.
(60) Provisional application No. 61/101,755, filed on Oct. 1, 2008.

(51) Int. Cl. G06F 9/44

(52) U.S. Cl. 718/100

(57) ABSTRACT

A system and method for dataflow analysis includes inputting a concurrent program comprised of threads communicating via synchronization primitives and shared variables. Synchronization constraints imposed by the primitives are captured as an intersection problem for bounded languages. A transaction graph is constructed to perform dataflow analysis. The concurrent program is updated in accordance with the dataflow analysis.

### RELATED APPLICATION INFORMATION

This application claims priority to provisional application Ser. No. 61/023,114 filed on Jan. 24, 2008 and provisional application Ser. No. 61/101,755 filed on Oct. 1, 2008, both incorporated herein by reference.

### BACKGROUND

1. Technical Field

The present invention relates to dataflow analysis in concurrent programs and more particularly to systems and methods for deciding location reachability and determining locations affected by other threads in concurrent programs.

2. Description of the Related Art

Dataflow analysis is an effective and indispensable technique for analyzing large scale real-life sequential programs. For concurrent programs, however, it has proven to be an undecidable problem. This has created a huge gap in terms of the techniques required to meaningfully analyze concurrent programs (which must satisfy the two key criteria of achieving precision while ensuring scalability) and what the current state-of-the-art offers.

The key obstacle in the dataflow analysis of concurrent programs is to determine for a control location l a given thread, how the other threads could affect dataflow facts at l. Equivalently, one may view this problem as one of precisely delineating transactions, i.e., sections of code that can be executed atomically, based on the dataflow analysis being carried out. The various possible interleavings of these atomic sections then determine interference across threads. This question, in turn, boils down to pair-wise reachability, i.e., whether a given pair of control locations in two different threads are simultaneously reachable. Indeed, in a global state g, a context switch is required at location l of thread T where a shared variable sh is accessed only if starting at g some other thread currently at location m can reach another location m′ with an access to sh that conflicts with l, i.e., l and m′ are pairwise reachable from l and m. In that case, we need to consider both interleavings wherein either l or m′ is executed first thus requiring a context switch at l.

A simple strategy for dataflow analysis of concurrent program includes three main steps: (i) compute the analysis-specific abstract interpretation of the concurrent program, (ii) delineate the transactions, and (iii) compute dataflow facts on the transition graph resulting by taking all necessary interleavings of the transactions. These abstractly interpreted threads can be naturally modeled as Pushdown systems (PDSs). A PDS has a finite control part corresponding to the valuation of the variables of the program and a stack which provides a means to model recursion. Step (ii) then reduces to pairwise reachability of interacting PDSs in the presence of scheduling constraints imposed by the synchronization primitives. While the reachability problem for a single PDS is efficiently decidable, it becomes undecidable for PDSs interacting via standard synchronization primitives like locks, rendezvous (Wait/Notify) and broadcasts (Wait/NotifyAll). This is the key reason for the tractability gap between dataflow analysis of sequential and concurrent programs.

### SUMMARY

A technical reason why interprocedural dataflow analysis is undecidable for concurrent programs is that it is easy to formulate the problem of deciding the dis-jointness of the context-free languages accepted by two given PDSs (which is undecidable) as a model checking problem. Using most synchronization primitives including locks, Wait/Notify style rendezvous, it is easy to couple the PDSs corresponding to two threads tightly enough to take the intersection of the context free languages accepted by them. Then, deciding the non-emptiness of the intersection of these context-free languages (which is undecidable) can easily be posed as a pairwise reachability problem.

We exploit the fact that most programmers use synchronization primitives in a very restrictive fashion. The reason for this is not hard to understand. A non-trivial use of synchronization makes it nearly impossible for programmers to reason about their code. We leverage the use of bounded languages as a means to bypass this intractability barrier.

A prime example of the restrictive use of synchronization primitives is practice of nested locks usage. Concurrent programs are said to access locks in a nested fashion if along each computation of the program a thread can only release the last lock that it acquired along that computation and that has not yet been released. Practical programming guidelines used by software developers often require that locks be used in a nested fashion. In fact, in Java (version 1.4) and C# locking is syntactically guaranteed to be nested. It has been shown that by exploiting nesting one can give efficient deciding procedure not just for pairwise reachability but full-blown LTL. On the other hand, even pairwise reachability remains undecidable if we allow unrestricted lock usage.

Even though the use of nested locks remains the most popular paradigm there are niche applications, like databases, where lock chaining is required. Chaining occurs when the scope of two mutexes overlap. When one mutex is required the code enters a region where another mutex is required. After successfully locking that second mutex, the first is no longer needed and is released. This technique is very useful in traversing data structures like trees or linked lists, instead of locking the entire data structure, with a single mutex and thereby preventing any parallel access each node or lock has a unique mutex. A second classic example where non-nested locks frequently occur is programs that use both mutexes and Wait/Notify statements. Both in Java and the Pthreads Library Wait/Notify statements require the usage on mutexes on an object being waited on. These mutexes typically interact with existing locks in code to produce non-nesting. Finally, the results on nested locks do not handle the case of recursive locks.

Exploiting programming patterns for tractability can also be carried out for the Wait/Notify style primitives. A classical result shows that for threads interacting via rendezvous, even reachability becomes undecidable. However that construction requires a complex use of rendezvous interacting with recursive procedure calls. In practice, however, rendezvous are used in a very restrictive sense—typically for producer consumer scenario, for enforcing barrier synchronization. etc., and their use in recursive functions in simplistic at best.

It has been shown that a fundamental obstacle (undecidability) is that using rendezvous one can couple threads tightly enough to take the intersection of the context-free languages generated by them. Then testing the non-emptiness of the intersection of two context-free languages can be encoded as an instance of a concurrent dataflow problem. The undecidability of the dataflow problem extends to all the standard synchronization primitives with the exception of nested locks. However, all these undecidability results hinge on a complex use of synchronization primitives interacting tightly with recursion. In practice, however, most programmers use synchronization primitives in a very restrictive fashion else it becomes nearly impossible for them to reason about their code. In this context, we exploit the key observation that, in practice, the language generated by synchronization primitives of a thread does not have the full power of context-freedom but can be captured via a bounded language. A context-free language is called bounded if it is a subset of a regular language of the form w₁*. . . wₙ*, where w₁, . . . , wₙ are fixed (not necessarily distinct) words. Bounded languages have the crucial property that the non-emptiness of the intersection of a context-free and a bounded language is decidable. This removes the fundamental obstacle in the tractability of dataflow analysis.

Leveraging bounded languages permits us to provide a framework for tractable dataflow analysis of concurrent programs that captures in a unified manner the frequently used programming patterns involving both locks and rendezvous. Our new framework can handle, not only nested locks as a special case, but, more generally, programs with non-nested locks involving the use of standard tools like lock chaining, recursive locks, rendezvous and non-nested interactions of locks and rendezvous.

A system and method for dataflow analysis includes inputting a concurrent program comprised of threads communicating via synchronization primitives and shared variables. Synchronization constraints imposed by the primitives are captured as an intersection problem for bounded languages. A transaction graph is constructed to perform dataflow analysis. The concurrent program is updated in accordance with the dataflow analysis.

A system for dataflow analysis of a concurrent program includes a concurrent program having threads communicating via synchronization primitives and shared variables. A processor is configured to receive the concurrent program for a dataflow analysis. The dataflow analysis includes capturing synchronization constraints imposed by the primitives as a bounded language model which treats the synchronization constraints as an intersection problem for bounded languages to permit the dataflow analysis to be decidable. The processor is further configured to construct a transaction graph to perform the dataflow analysis. A user interface is configured to update the concurrent program and repair bugs in accordance with the dataflow analysis.

These and other features and advantages will become apparent from the following detailed description of illustrative embodiments thereof, which is to be read in connection with the accompanying drawings.

### BRIEF DESCRIPTION OF DRAWINGS

The disclosure will provide details in the following description of preferred embodiments with reference to the following figures wherein:

FIG. 1 is a block/flow diagram of a system/method for dataflow analysis of concurrent programs in accordance with one embodiment;

FIG. 2 is an example program for demonstrating the present principles;

FIG. 3 is an illustrative program employed to show lock interactions for demonstrating the present principles;

FIG. 4 is an illustrative program for computing a lock causality graph for demonstrating the present principles;

FIG. 5 is a block/flow diagram of a system/method for dataflow analysis based on threads interacting through synchronizations primitives using bounded languages in accordance with one embodiment; and

FIG. 6 is a block diagram of a system for dataflow analysis of concurrent programs using bounded languages in accordance with one embodiment.

### DETAILED DESCRIPTION OF PREFERRED EMBODIMENTS

In accordance with the present principles, the use of bounded languages is employed as a unifying framework to capture frequently used programming patterns. We exploit the fact that the language of primitives generated by a recursive program does not have the full power of context freedom and can in fact be captured as a bounded language. A context-free language is called bounded if it is a subset of a regular language of the form w₁* . . . wₙ*, where w₁, . . . , wₙ are fixed words. Bounded languages have the property of non-emptiness of the intersection of a context-free language, which is decidable. This removes the fundamental obstacle in deciding pair-wise reachability as leading to a tractable framework for dataflow analysis.

Embodiments described herein may be entirely hardware, entirely software or including both hardware and software elements. In a preferred embodiment, the present invention is implemented in software, which includes but is not limited to firmware, resident software, microcode, etc.

Embodiments may include a computer program product accessible from a computer-usable or computer-readable medium providing program code for use by or in connection with a computer or any instruction execution system. A computer-usable or computer readable medium may include any apparatus that stores, communicates, propagates, or transports the program for use by or in connection with the instruction execution system, apparatus, or device. The medium can be magnetic, optical, electronic, electromagnetic, infrared, or semiconductor system (or apparatus or device) or a propagation medium. The medium may include a computer-readable medium such as a semiconductor or solid state memory, magnetic tape, a removable computer diskette, a random access memory (RAM), a read-only memory (ROM), a rigid magnetic disk and an optical disk, etc.

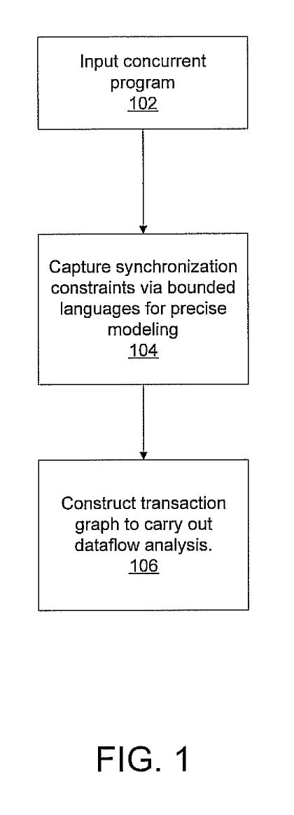

Referring now to the drawings in which like numerals represent the same or similar elements and initially to FIG. 1, a block/flow diagram shows a system/method for tractable dataflow analysis for concurrent programs in accordance with the present principles. In block 102, a concurrent program P having a pair of thread locations is input to an analyzer for dataflow analysis. In block 104, synchronization constraints are captured using bounded languages to provide more precise modeling of the dataflow. In block 106, a transaction graph is constructed to carry out the dataflow analysis. A more detailed explanation of the present principles follows.

We consider the problem of static warning generation for data race bugs in concurrent programs. Classical warning generation has three main steps: (i) determine all control locations in each thread with shared variable accesses, (ii) compute the set of locks held at each of these locations, and (iii) each pair of control locations in different threads where (a) the same shared variable is accessed. (b) at least one of these accesses is a write operation, and (c) disjoint locksets are held, is flagged a potential data race site.

The main weakness of lockset-based static warning generation techniques is that too many bogus warnings may be generated. The key reason for this is that such techniques typically ignore conditional statements, and so locations c₁ and c₂ in different threads constituting a data race warning might not be pairwise reachable in the given concurrent program. However, using dataflow analysis such as constant folding, interval analysis, octagon analysis and polyhedral analysis (lifted to concurrent programs), a significant fraction of these bogus warnings can be weeded out.

Block 106 computes the Product Transaction Graph by performing the following:
1: Construct the product transaction graph Gₙ by using only lock and rendezvous constraints.
2: Repeat
3: Compute range/octagonal/polyhedral invariants and, if possible, prune paths from Gₙ resulting in Hₙ.
4: Compute a new product transaction graph Gₙ taking into account the pruning that results in Hₙ.
5: Until no more pruning can be carried out.

To carry out any dataflow analysis, we first need to use pairwise reachability information to delineate the transactions of the given concurrent program. In determining pairwise reachability, we handle (i) synchronization constraints via our new procedures for parameterized reachability, and (ii) data constraints via sound invariants like octagons, etc. Note that unlike synchronization primitives, parameterized pairwise reachability is undecidable for PDSs interacting via shared variables which is why these constraints are handled via sound invariants.

First, an initial set of (coarse) transactions is identified by using parameterized pairwise reachability based only on synchronization constraints and ignoring shared variables (step 1 of block 106). These transactions are then used to compute the initial set of octagonal/polyhedral invariants (step 3 of block 106). However, based on these sound invariants, it may be possible to prune away unreachable parts of the program. On this sliced program, we again compute (synchronization based) parameterized pairwise reachable control states which may yield larger transactions (step 4 of block 106). This, in turn, may lead to sharper invariants. The process of progressively refining transactions by leveraging synchronization constraints and sound invariants in a dove-tailed fashion continues until we reach a fix-point.

System Model: We consider concurrent programs comprised of threads that communicate using shared variables and synchronize with each other using standard primitives such as locks, rendezvous. etc.

Program Representation. Each thread in a concurrent program is represented by means of a set of procedures F, a special entry procedure mainᵢ and a set of global variables G. Each procedure pεF, is associated with a tuple of formal arguments args(p), a return type tₚ, local variables L(p) and a control flow graph (CFG) representing the flow of control. The control flow graph includes a set of nodes N(p) and a set of edges E(p) between nodes in N(p). Each edge m→nεE(p) is associated with an action that is an assignment, a call to another procedure, a return statement, a condition guarding the execution of the edge or a synchronization action. The actions in the CFG for a procedure p may refer to variables in the set G∪{p}∪L(p). The semantics of these actions are quite standard.

A nultithreaded program Π includes a set of threads T₁, . . . , T_{N} for some fixed N>0 and a set of shared variables S. Each thread Tᵢ is associated with a single threaded program Πᵢ including an entry function eᵢ. Note that every shared variable sεS is a global variable in each CFG Πᵢ. Threads synchronize with each other using standard primitives like locks, rendezvous and broadcasts. Of these primitives the most commonly used are locks. Rendezvous find limited use in niche applications like web services, e.g., web servers like Apache and browsers like Firefox; and device drivers, e.g., autofs. Broadcasts are extremely rare and hard to find in open source code. In this disclosure, we shall, therefore consider only concurrent programs comprised of threads synchronizing via locks and rendezvous described below.

Locks: Locks are standard primitives used to enforce mutually exclusive access to shared resources.

Rendezvous: Rendezvous are motivated by Wait/Notify primitives of Java and pthread_cond_wait/pthread_cond_send functions of the Pthreads library. The rendezvous transitions of a thread Tᵢ are represented by transitions labeled with rendezvous send and rendezvous receive actions of the form a! and b?, respectively, a pair of transitions labeled with l! and l? are called matching. A rendezvous transition tr₁:

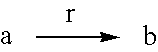

of a tread Tᵢ is enabled in global state s of a concurrent program, if these exists a thread Tⱼ other than Tᵢ, in local state c such that there is a matching rendezvous transition of the form tr₂:

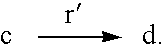

To execute the rendezvous, both the pairwise send and receive transitions tr₁ and tr₂ must be fired synchronously with T₁ and Tⱼ transiting to b and d, respectively, in one atomic step. Note that in Java, the Notify (send) statement can always execute irrespective of whether a matching Wait statement is currently enabled or not. However, we assume for the sake of simplicity that if the Wait and Notify statements always match up else static warning generation enumerates too many bogus warnings.

In order to exploit bounded languages for dataflow analysis for concurrent programs, there are three steps. (1) Decide whether the language of each (abstractly interpreted) thread in the given program is bounded. (2) In each thread, compute the bounded language accepted by each control state. Note this analysis is thread-local, i.e., done separately for each thread instead of the entire concurrent program. (3) Determine the pairwise reachability of two control states as needed by the dataflow analysis at hand by using the fact that two control states are pairwise reachable if the languages accepted by these control states have a non-empty intersection.

Before proceeding further, we need to determine whether the language accepted by each thread is bounded. Towards that end, a (sequential) dataflow analysis is provided that traverses the control flow graph (CFG) of the given thread and determines whether the language generated by the G at each state (defined formally below) is bounded.

We recall that dataflow analysis for a sequential program proceeds by first using abstract interpretation to discard program details not relevant to the dataflow analysis at hand. Conditional statements are typically ignored so that in the control flow graph (CFG) of a given thread transitions between control states that are not guarded. In other words, all branches corresponding to conditional statements in the CFG can potentially be executed. We thus assume that transitions in G are not guarded. Additionally, we assume that G has transitions labeled with pairwise rendezvous send and receive labels that are used to synchronize with other threads.

We observe that if c₁ and c₂ are control locations in two different threads, then c₁ and c₂ are simultaneously reachable if the language of the synchronization primitives accepted by the c₁ and c₂ in their respective threads have a non-empty intersection. This is essentially because of the semantics of a pairwise rendezvous transition which uses the send and receive transitions to match up in order to fire.

Given a node in the CFG of the given thread, the language accepted by c, denoted by L(c), is the set of words w such that there is a context-sensitive (respecting function calls and returns) path from the initial state of the CFG to c labeled with w.

Lemma: Control states c₁ and c₂ are simultaneously reachable iff L(c₁)∪L(c₂)≠0. Since deciding the non-emptiness of this intersection of languages L(c₁) and L(c₂) is undecidable, in general, but decidable for the case of bounded languages, it is important to first determine for c belonging to a given thread, whether L(c) is bounded.

We start by observing that to determine boundedness of L(c), it is sufficient to show that the language accepted by each strongly connected component of the CFG of the given thread is bounded. Towards that end, given a strongly connected component S and anode a of S we define the Lₛ(c) as the set of words w such that there is a context-sensitive cycle starting and ending at s labeled with w, Then we can show that:

Theorem: For each state c, L(c) is bounded iff for each stated, L(d) is bounded.

Theorem: Let S be a strongly connected component of the CFG of the given thread and c a node of S. Then if Lₛc is bounded there do not exist cycles π₁ and π₂ in S starting at c and labeled with w₁ and w₂ such that w₁ and w₂ are non-commutative, I.e., w₁w₂≠w₂w₁.

Before proceeding to the sufficient condition, we need the following simple lemma.

Lemma Given two words w₁ and w₂, w₂w₁ iff there exists a word w such that w₁=w^{m} and w₂=wⁿ.

Lemma. Given a strongly connected component S, if there do not exist cycles π₁ and π₂ in S starting (and ending) at c labeled w₁ and w₂ such that w₁w₂ ≠w₂w₁, then for each node c of S there exists a word wₛ such that each cycle starting and ending at s is labeled with a word in wₛ*. The next lemma clarifies the structure of the language L(S,n).

Theorem: L(S,n) is of the form wⁿ^{₁}^{l}^{₁}^{+ . . . +n}^{ₖ}^{l}^{ₖ}, where w, is a fixed word, l₁, . . . , lₖ are fixed integers and n₁, . . . , nₖ are arbitrary integers. This leads to the sufficiency result.

Theorem: Given a strongly connected component (SCC) S, if there do not exist cycles c₁ and c₂ in S starting at S labeled with w₁ and w₂ such that w₁w₂≠w₂w₁ then Lₛ(c) is bounded.

The above result reduces the problem of deciding the boundedness of L(S) to the deciding whether for any two cycles starting at sw₁ and w₂ are of the form w^{m} and wⁿ, where m,n≧0. The idea behind the present methods is to first compute a small number of potential candidates for w and then check for each candidate whether the language Lₛ(c) belongs to w*.

Towards that end, we consider the shortest cycle starting and ending at c accepting a non-empty word u. Note that such a cycle has length at most 2|S|, where |S| is the cardinality of the set of control states S of a given thread. It follows that it is of the form u=wⁿ, for some n. This gives a finite set of candidates (at most 2|S|) for w. Then, the problem reduces to checking for candidate c whether the language of the system is in c*. This can be accomplished for recursive programs by using standard methods for model checking PDSs.

Block 104 of FIG. 1 includes recognizing bounded languages. This can be performed in accordance with the following method.

Recognizing bounded languages:

1: Input: The control flow graph G of a given program where
for each function call the function entry location is the
successor of each call site for the function.
2: Compute the SCCs S₁,...,S_{c} of G
3: for each strongly connected component (SCC) Sᵢ do
4: for each state s of Sᵢ do
5: pick a transition tr:a→b labeled with a non-
empty symbol
6: compute paths p₁ and p₂ of minimal length
from s to a and b to s, respectively
7: Let u be the word accepted by the cycle c
that first traverses p₁ executed tr and then executes p₂
8: Compute all possible words w such that u
can written as u” for some n
9: for each word u do
10: Model check to determine whether the
language of S is a subset of w*
11: if L(S)⊂ w* then
12: output true
13: end if
14: end for
15: end for
16: end for

Locks: Locks are clearly the most commonly used synchronization primitive. Unfortunately, however, the problem for pairwise reachability is undecidable, in general, for threads interacting (purely) via locks. Even though the problem is undecidable in general, it has been shown that for the special case of nested locks it becomes efficiently decidable. While nesting is the most popular paradigm of lock usage there are certain niche applications where lock chaining is used.

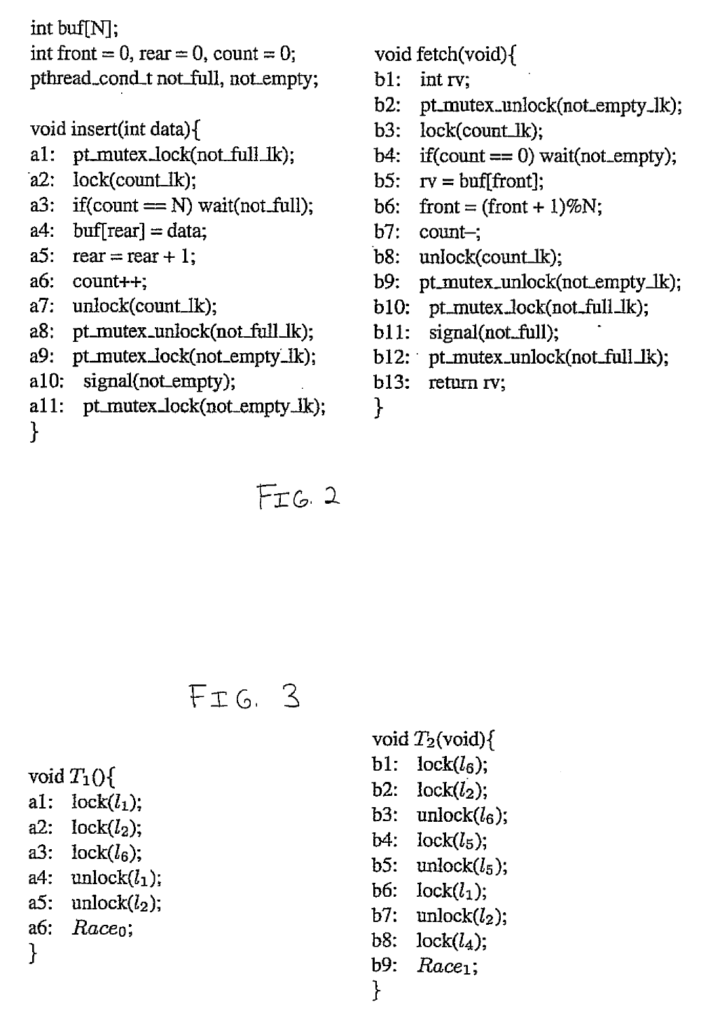

Referring to FIG. 2, an example program is depicted where non-nested locks frequently occur from the inter-action of locks and wait/Notify statements. Consider a class buffer implementing a monitor for a bounded buffer. The variable “count” tracks the number of elements that are currently in the buffer. Before a new element can be inserted in the buffer via “insert”, the value of count is checked to see whether the buffer is full. If it is then the thread inserting an element waits until there is space in the buffer.

Since count is shared by multiple threads, it is locked before every access, using count_lk. If the buffer is full the thread inserting an object waits on object not_full (in line a3) until it receives a signal from a thread deleting an element (line b11). Both Java and Pthreads require that before the wait and signal operations is called on an object, a lock associated with that object is acquired (lines a1, a9, b2, b10). However, the semantics of the wait(obj) statement is that the lock obj_lk associated with obj must be released while the thread is waiting on obi. When the waiting thread receives a wakeup signal, obj_lk is re-acquired. Thus, in effect, each wait statement can replaced by a lock(obj_lk) followed by a unlock(obj_lk). In that case, however, the locking in the example no longer remains nested as the last lock that was acquired before a3 was count_lk and not not_full_lk. Note that it was the hidden locking in the execution of wait statement that caused the non-nested access even though if we ignore the wait statements the locking remains nested. In this example, we showed how nesting of locks can be violated in just one monitor. The problem gets much worse if we consider nested monitors.

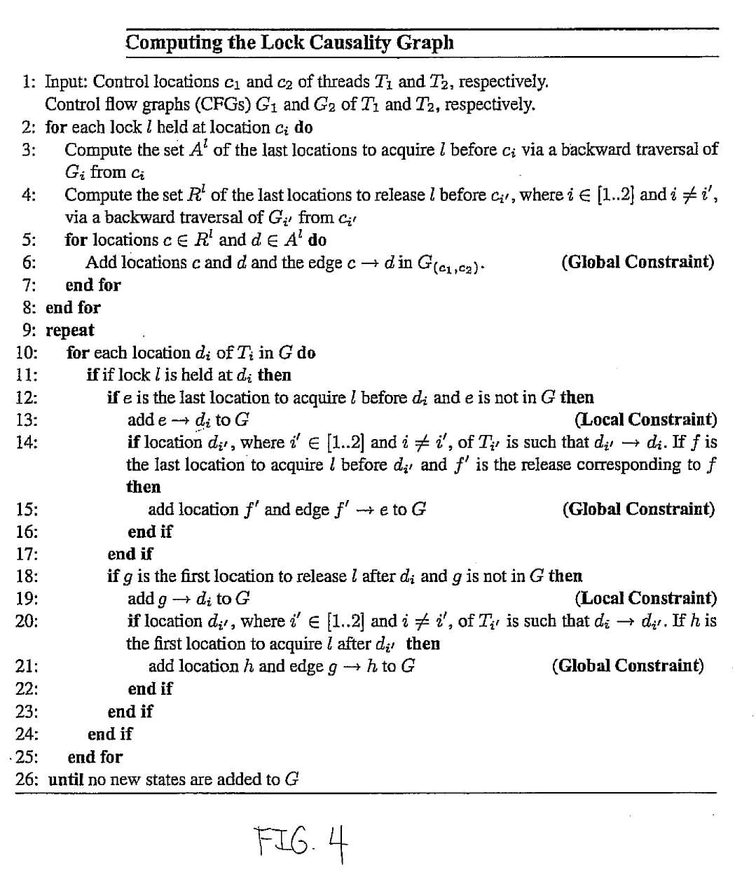

Pairwise Reachability for Non-nested Locks: Referring to FIG. 3, we start by formulating a necessary and sufficient condition for pairwise reachability of control locations in two threads interacting via locks. Note that pairwise reachability is important not just for dataflow analysis of concurrent programs but also lockset based data race detection. This result then allows us to reduce pairwise reachability to the non-emptiness of the intersection of two context-free languages induced by the relevant set of locks for which we leverage our new results on bounded languages.

Consider the example concurrent program P comprised of threads T₁ and T₂ shown in FIG. 3. Suppose that we are interested in deciding whether a6 and b9 are simultaneously reachable in FIG. 3. We start by constructing a lock causality graph C_{(a6,b9)} that captures the constraints imposed by locks on the order in which program statements of P need to be executed in order for it to simultaneously reach a6 and b9. The nodes of this causal graph are (the relevant) control locations of the two threads having locking statements. For locations c₁ and c₂ of C_{(n6,b9)} there exists an edge from c₁ to c₂, denoted by c₁→c₂, if c₁ must be executed before c, in order for P to simultaneously reach a6 and b9.

The lock causality graph captures both local and global constraints as we now illustrate. The local constraints essentially encode the relevant lock chains. We start by observing that at b9, T₂ possesses l₁ due to b6, the last statement to acquire l₁ before T₂ reaches b6. Thus, b6→b9. Furthermore, since lock l₂ is held at b6, the last transition to acquire l₂ before b6, i.e., b2, must be executed before b6. Thus, b2→b4. Similarly, b1→b2.

We can also deduce global causal constraints. Consider lock l₁, held at b9. Note that once T₂ acquires l₁ at location b6, it does not release it until after it has exited b9. In other words, once T₂ acquires l₁ at b6, T₁ cannot acquire it again. Thus if T₁ and T₂ are to simultaneously reach a6 and b9, the last transition of T₁ that releases l₁ before reaching a6, i.e., a4, must be executed before b6 resulting in the addition of a4→b6.

Global causal constraints can be deduced another way. Consider the global constraint a4→b6. Note, that at location b6 lock l₂ is held which was acquired at b2. Also, once l₂ is acquired at b2 it is not released until after T₂ exits b6. Thus if l₂ has been acquired by T₁ before reaching a5 it must be released before b2 (and hence b6) can be executed. In our example, the last statement to acquire l₂ before a5 is a2. The unlock statement corresponding to a2 is a5. Thus, a5→b2. Note that it could have happened that the lock release of l₂ occurs before a5.

The method to compute the lock causality graph is a simple fix point computation formalized below. Given lock l and control location d of thread T, we say that c is the last transition to acquire (release) l before d if (i) either l is acquired(released) at c or it is the initial location, and (ii) there exists a path in the CFG of T from c to d along which l is not acquired(released) except possible at c. Analogously, we say that d is the first location to acquire(release) lock l after c if (i) either l is acquired(released) at d or it an exit location of P, and (ii) there exists a path in the CFG of from T to c along which d is not acquired(released) except possibly at d.

Note that in constructing the causal graph we add only the relevant locking statements. Indeed, in our example of FIG. 3 the statements b4 and b5 acquiring and releasing l₅ are not added to G. The key reason is that l₅ is locally nested, as at location b5 it is also the last lock to be acquired that has not been released. Thus, it does not interact with other locks (through chaining) and accordingly no causal constraints involving it are added to G. Thus it follows that for the case of nested locks, G_{(c}_{₁}_{,c}_{₂}₎ will only have locations where the locks held at c₀ and c₂ are acquired.

Note that due to causality introduced for a6 and b9 to be reachable the lock causality graph has to be acyclic. In fact it turns out that acyclicity is also a sufficient condition. However, testing of acyclicity is complicated by the fact that each edge in the lock causality graph represents not one constraint but a set of constraints. This can happen, for instance, it a state involved in an edge of occurs in a loop or a recursive function.

We start by identifying cyclic topics of control locations occuring in G_{(c}_{₁}_{,c}_{₂}₎. Let locations e₁ and fᵢ of Tᵢ be such that (i) all four locations belong to G, (ii) there is a path from eᵢ to fᵢ in Tᵢ, (iii) the edges f₁→e₁ and f₂→e₁ belong to G. Then there exists a cycle in G involving e₁,f₁,e₂,f₂. We call such a tuple tup=(c₁,d₁,c₂,d₂) cyclic. Given a pair of local paths of T₁ leading to c₁ there may be multiple instances of eᵢ and fᵢ occuring along x₁. However, only one cycle suffices to rule out a valid computation.

That instance can taken to be the cycle involving the last instances of eᵢ and fᵢ occuring along x₁. We say that a pair of paths x₁ and x₂ in G₁ and G₂, respectively, avoids tuple tup for some i,xᵢ does not pass through an instance of c₁ followed by dᵢ.

Let G_{cyc} be the set of all cyclic tuples in G. Theorem; Locations c₁ and c₂ are pairwise reachable if there exist local paths x₁ and x₂ of T₁ and T₂, respectively, leading to c₁ and c₂ that avoid each tuple tup εG_{(c}_{₁}_{,c}_{₂}₎.

Referring to FIG. 4, an illustrative method for computing a Lock Causality Graph is depicted. At line 1: Input: Control locations c₁ and c₂ of threads T₁ and T₂, respectively, and control flow graphs (CFGs) G₁ and G₂ of T₁ and T₂, respectively. At line 2, for each lock l held at location c₁, compute the set A¹ of the last locations to acquire l before c₁ via a backward traversal of G₁ from c₁, and compute the set R¹ of the last locations to release l before cₚ, where iε[1 . . . 2] and i≠i′ via a backward traversal of Gₚ from cₚ. At line 5, for locations cεR¹ and dεA¹, add locations c and d and the edge c→d in G_{(c}_{₁}_{,c}_{₂}₎ (Global Constraint). For each locations d₁ of T₁ in G, if lock l is held at d₁ and if e is the last location to acquire l before d₁ and e is not in G then add e→d, to G. At lines 14-15, if location d₁, where iε[1 . . . 2] and i∫i′ of T₁ is such that dₚ→d₁. If f is the last location to acquire l before dₚ and f′ is the release corresponding to f then, add location f′ and edge f′→e to G. (Global Constraint).

At line 18, if g is the first location to release l after dᵢ and g is not in G then add g→dᵢ to G. If location dₚ, where iε[1 . . . 2] and i≠i′ of Tᵢ is such that d₁→dₚ. If h is the first location to acquire l after dₚ then add location h and edge g→h to G. (Global Constraint). This is performed until no new states are added to G at line 26.

Language Theoretic Formulation of Pairwise Reachability: To leverage the use of bounded languages, we need to translate the necessary and sufficient condition expressed in the theorems in a language theoretic form. Thus, the question becomes determining the set of paths avoiding each tuple tup=(c₁,d_{,}c₂,d₂)χG. Towards that end, we transform each thread by adding extra no-op statements c₁′ and dᵢ′ after cᵢ and dᵢ, respectively, and making each successor of cᵢ a successor of d₁. Next, we label statements cᵢ′ and d₂′ with σ and d₁′ and c₂′ with δ. Let T₁^{tup} and T₂^{tup} be the resulting threads. Then, the following result is immediate.

Theorem: There exists a pair of paths avoiding tup iff L(T₁^{tup})∪L(T₂^{tup})≠0. Let G_{cyc}={tup₁, . . . , tupₖ}. To ensure that all tuples are voided, we build a sequence of transformed threads Tᵢ¹, . . . , T₁^{k} where T₁^{k} is T₁^{k-1}(tup). Then, all tuples in G_{cyc} are voided iff control states c₁ and c₂ are pairwise reachable iff (L(T₁^{k})∪L(T₂^{k})=0.

Nested Locks. We show that decidability of reachability for nested locks follows as a simple corollary. Let L₁ and L₂ be the locks held at c₁ and c₂. Then we have that G_{(c}_{₁}_{,c}_{₂}₎ comprises only of the nodes where c₁ and c₂ are held. Let G_{cyc} be the set of cyclic tuples of G_{(c}_{₁}_{,c}_{₂}₎. Then we claim that L(Tᵢ^{k}) is bounded.

Among prior work on the verification of concurrent programs, attempts have been made to generalize the techniques to model check pushdown systems communicating via CCS-style pairwise rendezvous. However, since even reachability is undecidable for such a framework, the procedures are not guaranteed to terminate in general but only for certain special cases. The idea is to restrict interaction among the threads so as to bypass the undecidability barrier. Another conventional way to obtain decidability is to explore the state space of the given concurrent multi-threaded program for a bounded number of context switches among the threads.

We have provided parameterization as a form of abstraction which when used in conjunction with abstract interpretation can provide a tractable framework for dataflow analysis of concurrent programs. We have delineated the decidability boundary of the Parameterized Model Checking Problem (PMCP) for PDSs interacting via each of the standard synchronization primitives for doubly-indexed LTL. We have demonstrated that, contrary to expectation, in many cases of practical interest, the PMCP is more tractable than the standard model checking problem. Leveraging this insight has helped us is making vital inroads into the problem of dataflow analysis far concurrent programs.

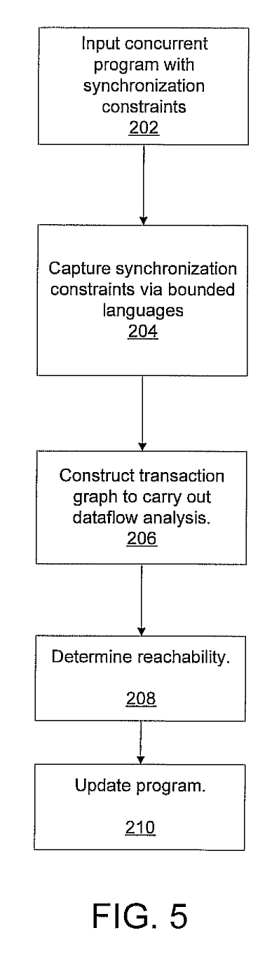

Referring to FIG. 5, a system/method for dataflow analysis is illustratively depicted. In block 202, a concurrent program having at least one synchronization constraint between two threads is input for analysis. The synchronization constraint includes a synchronization primitive such as, e.g., a lock and/or a rendezvous. The concurrent program is comprised of threads communicating via synchronization primitives and shared variables.

In block 204, the at least one synchronization constraint or primitive is captured to model the synchronization constraint as a bounded language. Synchronization constraints imposed by the primitives are captured as an intersection problem for bounded languages. Occurring patterns in the concurrent program are employed wherein language generated by the synchronization constraints is a bounded language. A transaction graph is constructed to perform the dataflow analysis in block 206. A non-empty intersection between two bounded languages is preferably employed to enable the dataflow analysis. The dataflow analysis includes determining reachability for a pair of locations in block 208.

In block 210, the concurrent program is updated in accordance with the dataflow analysis. The program is fixed to remove conflicts such as data races or to others correct problems. This may be performed manually by a user or automatically via a computer/software.

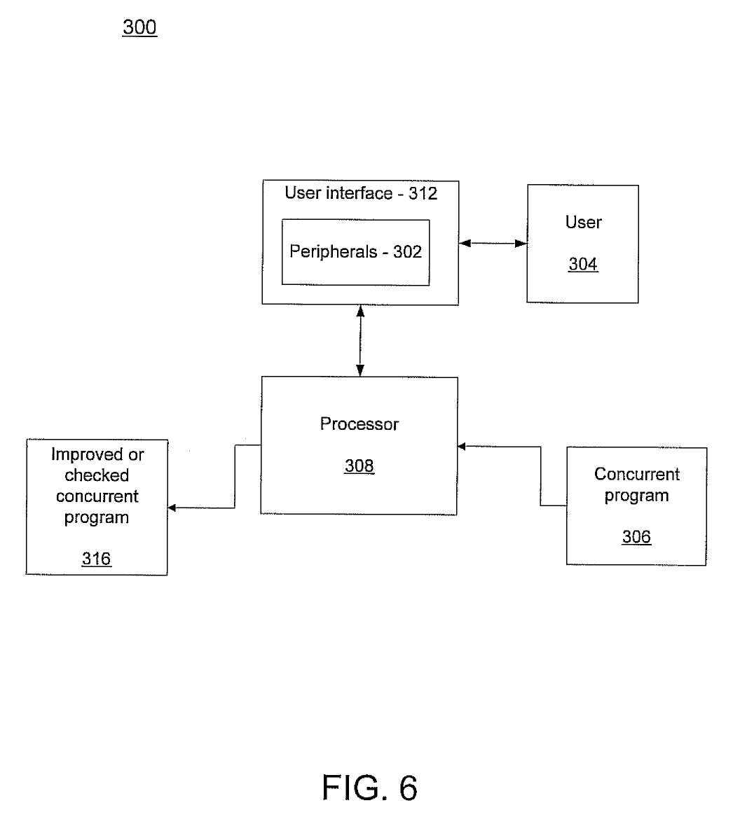

Referring to FIG. 6, a system 300 for performing dataflow analysis on concurrent programs is illustratively shown. The system is preferably implemented with hardware elements such as a computer processor or processors which are controlled or function in conjunction with software elements. The system 300 may be part of a debugging or program checking work station and may include peripheral devices 302 (e.g., key board, mouse, display, etc.) for interaction between a user 304 and the system 300. The system 300 receives as input a concurrent program 306 having at least one pair of locations in two threads interacting via synchronization constraints or primitives (e.g., locks and/or rendezvous. The concurrent program includes reoccurring patterns which are employed to model the synchronization constraints as a bounded language.

A processor 308 receives the concurrent program for analysis. The processor 30B performs the needed operations to receive the concurrent program for a dataflow analysis, the dataflow analysis including capturing and modeling the at least one synchronization constraint as a bounded language wherein the bounded language models the at least one synchronization constraint to permit the dataflow analysis to be decidable. The dataflow analysis determines reachability for a pair of locations.

The processor 308 is also configured to construct a transaction graph to perform the dataflow analysis. The transaction graph includes at least one intersection between two bounded languages to enable a determination of decidability if a non-empty intersection is found.

A user interface 312, which includes peripherals 302 is configured to update the concurrent program and repair bugs in accordance with the dataflow analysis. In this way, the checked concurrent program is output 316 as an improved program (or checked) for execution in any number of useful applications.

Having described preferred embodiments of a system and method tractable dataflow analysis for concurrent programs via bounded languages (which are intended to be illustrative and not limiting), it is noted that modifications and variations can be made by persons skilled in the art in light of the above teachings. It is therefore to be understood that changes may be made in the particular embodiments disclosed which are within the scope and spirit of the invention as outlined by the appended claims. Having thus described aspects of the invention, with the details and particularity required by the patent laws, what is claimed and desired protected by Letters Patent is set forth in the appended claims.

What is claimed is:

1. A method for dataflow analysis, comprising:
inputting a concurrent program comprised of threads communicating via synchronization primitives and shared variables;
capturing synchronization constraints imposed by the primitives as an intersection problem for bounded languages;
constructing a transaction graph to perform dataflow analysis; and
updating the concurrent program in accordance with the dataflow analysis.

2. The method as recited in claim 1, wherein the synchronization primitive includes one of a lock and a rendezvous (wait/notify).

3. The method as recited in claim 1, wherein capturing includes employing occurring patterns in the concurrent programs wherein language generated by the synchronization constraints is a bounded language.

4. The method as recited in claim 1, wherein constructing a transaction graph to perform dataflow analysis includes deciding a non-empty intersection between two bounded languages to enable the dataflow analysis.

5. The method as recited in claim 1, wherein the dataflow analysis is used to determine reachability for a pair of locations.

6. A system for dataflow analysis of a concurrent program, comprising:
a concurrent program having threads communicating via synchronization primitives and shared variables;
a processor configured to receive the concurrent program for a dataflow analysis, the dataflow analysis including capturing synchronization constraints imposed by the primitives as a bounded language model which treats the synchronization constraints as an intersection problem for bounded languages to permit the dataflow analysis to be decidable, the processor further configured to construct a transaction graph to perform the dataflow analysis; and
a user interface configured to update the concurrent program and repair bugs in accordance with the dataflow analysis.

7. The system as recited in claim 6, wherein the synchronization primitive includes one of a lock and a rendezvous.

8. The system as recited in claim 6, wherein the concurrent program includes reoccurring patterns which are employed to model the synchronization constraints is a bounded language.

9. The system as recited in claim 6, wherein the transaction graph includes at least one intersection between two bounded languages to enable a determination of decidability if a non-empty intersection is found.

10. The system as recited in claim 6, wherein the dataflow analysis determines reachability for a pair of locations.

11. A computer readable medium comprising a computer readable program for dataflow analysis, wherein the computer readable program when executed on a computer causes the computer to perform the steps of:
inputting a concurrent program comprised of threads communicating via synchronization primitives and shared variables;
capturing synchronization constraints imposed by the primitives as an intersection problem for bounded languages;
constructing a transaction graph to perform dataflow analysis; and
updating the concurrent program in accordance with the dataflow analysis.

12. The computer readable medium as recited in claim 11, wherein the synchronization primitive includes one of a lock and a rendezvous (wait/notify).

13. The computer readable medium as recited in claim 11, wherein capturing includes employing occurring patterns in the concurrent programs wherein language generated by the synchronization constraints is a bounded language.

14. The computer readable medium as recited in claim 11, wherein constructing a transaction graph to perform dataflow analysis includes deciding a non-empty intersection between two bounded languages to enable the dataflow analysis.

15. The computer readable medium as recited in claim 11, wherein the dataflow analysis is used to determine reachability for a pair of locations.
